(19) United States
(12) Patent Application Publication
(10) Pub. No.: US 2026/0111458 A1
(43) Pub. Date: Apr. 23, 2026

(54) LLM-BASED CONFIDENTIAL CONTENT SANITIZATION SYSTEM

(71) Applicants: Advanced Micro Devices, Inc., Santa Clara, CA (US); ATI Technologies ULC, Thornhill (CA)

(72) Inventors: Linhui DING, Danyang (CN); Ilia BLANK, Concord (CA); Patrick Pak Kin FOK, Markham (CA); Le ZHANG, Markham (CA); Wei LIANG, Markham (CA); Junwei SHEN, Shanghai (CN); Seshadri Sekhar MADHUNAPANTULA, Hyderabad (IN); Sumalata HIREMATH, Richmond Hill (CA)

(21) Appl. No.: 18/919,101

(22) Filed: Oct. 17, 2024

(51) Int. Cl. G06F 16/332; G06F 21/62

(52) U.S. Cl. CPC G06F 16/3329; G06F 21/6218

(57) ABSTRACT

Embodiments herein relate to employing a RAG system to facilitate document sanitization. An LLM is provided with updated rules via a retrieval system database. The up-to-date rules of the database can be accessed by the LLM and applied to documents for sanitization. The retrieval system database may contain rules instructing the LLM to redact certain components of the documents. The retrieval system database can also be updated through the LLM via the LLM receiving natural language prompts with instructions to update the database with new rules, validate rules, and query for rules, among other things. In some embodiments, the LLM can update the retrieval system database according to changes the LLM detects in documents, deriving rules from the detected changes. The sanitized, or redacted documents outputted by the LLM according to the rules of the retrieval system database can be reworded to maintain user readability and grammatical structure.

### TECHNICAL FIELD

The embodiments presented relate to a retrieval augmented generation system (RAGS). RAGS enhance the capabilities of large language models (LLMs) by integrating a retrieval component that provides relevant information from external sources to the LLM.

### BACKGROUND

Document sanitization is the process of removing or altering sensitive information from documents. This may prevent unauthorized access or exposure, and can ensure that classified, confidential or personal data is not disclosed unintentionally when documents are shared, stored or published. Currently, techniques for document sanitization include manual redaction, such as blacking out or obscuring text, data masking such as manually replacing sensitive data with fictional data, and metadata removal such as manually eliminating hidden information embedded in a document. This reliance on manual input is time consuming, error prone, and insufficient for handling complex, large scale data.

### SUMMARY

Disclosed herein are a retrieval augmented generation system (RAGS) and methods for using the same. RAGS enhance the capabilities of large language models (LLMs) by integrating a retrieval component that provides relevant information from external sources to the LLM.

In one example, a method is provided that includes: receiving a first confidentiality rule defining a first confidential element contained in a plurality of documents; updating a retrieval system database to store the first rule, where the retrieval system database stores a plurality of defined rules that define a plurality of confidential elements; receiving the plurality of documents, at a large language model (LLM); redacting, using the LLM, the plurality of confidential elements defined by the rules stored in the retrieval system database from the plurality of documents, including the first confidential element defined by the first rule; and generating, using the LLM, redacted versions of the plurality of documents.

In another example, a system is provided that includes: one or more processors; and one or more memories configured to store an application, which, when executed by a combination of the one or more processors, causes the combination of the one or more processors to perform an operation, the operation including: receiving a first confidentiality rule defining a first confidential element contained in a plurality of documents; updating a retrieval system database to store the first rule, where the retrieval system database stores a plurality of defined rules that define a plurality of confidential elements; receiving the plurality of documents, at an LLM; redacting the plurality of confidential elements defined by the rules stored in the retrieval system database from the plurality of documents, including the first confidential element defined by the first rule; and generating redacted versions of the plurality of documents.

### BRIEF DESCRIPTION OF DRAWINGS

FIG. 1 illustrates a document sanitization system, according to some embodiments.

FIG. 2 illustrates a flowchart of generating redacted documents, according to some embodiments.

FIG. 3 illustrates defining a rule, according to some embodiments.

FIG. 4 illustrates a flowchart for defining a rule, according to some embodiments.

FIG. 5 illustrates deriving a rule, according to some embodiments.

FIG. 6 illustrates querying for a rule, according to some embodiments.

FIG. 7 illustrates a flowchart of querying for a rule, according to some embodiments.

### DETAILED DESCRIPTION

Embodiments herein relate to employing a RAG system to facilitate document sanitization. An LLM is provided with updated rules via a retrieval system database. The up-to-date rules of the database can be accessed by the LLM and applied to documents for sanitization. The retrieval system database may contain rules instructing the LLM to redact certain components of the documents. The retrieval system database can also be updated through the LLM via the LLM receiving natural language prompts with instructions to update the database with new rules, validate rules, and query for rules, among other things. In some embodiments, the LLM can update the retrieval system database according to changes the LLM detects in documents, deriving rules from the detected changes. The sanitized, or redacted documents outputted by the LLM according to the rules of the retrieval system database can be reworded to maintain user readability and grammatical structure.

This system provides improvements in efficiency, accuracy, and document security. Efficiency and accurately are improved as the LLM can constantly adapt to changing rules, and generate redacted documents according to those changed rules. Document security is improved as the LLM's capability to maintain readability of the documents makes it so the sanitized documents have minimal traces of the redacted data.

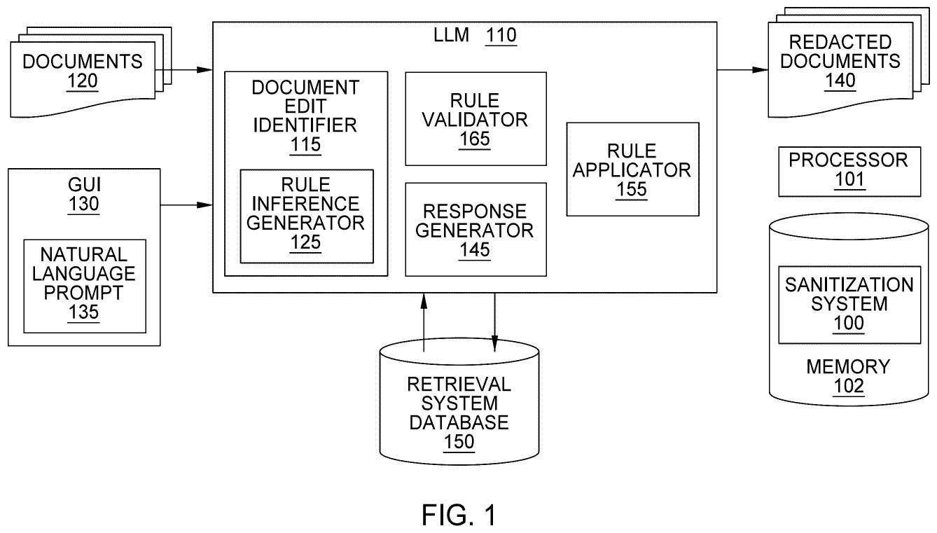

FIG. 1 illustrates the sanitization system 100. The sanitization system 100 can be implemented on a computing system with a processor 101, and a memory 102. The processor 101 generally retrieves and executes programming instructions stored in the memory 102. The processor 101 is representative of a single central processing unit (CPU), multiple CPUs, a single CPU having multiple processing cores, graphics processing units (GPUs) having multiple execution paths, specialized AI hardware accelerators (e.g., systems of a chip), and the like.

The memory 102 generally includes program code for performing various functions related to use of the sanitization system 100. The program code is generally described as various functional “applications” or “modules” within the memory 102, although alternate implementations may have different functions and/or combinations of functions. Within the memory 102, the sanitization system 100 facilitates document sanitization and updating and deriving rules in a retrieval system database, among other things. This is discussed further, below.

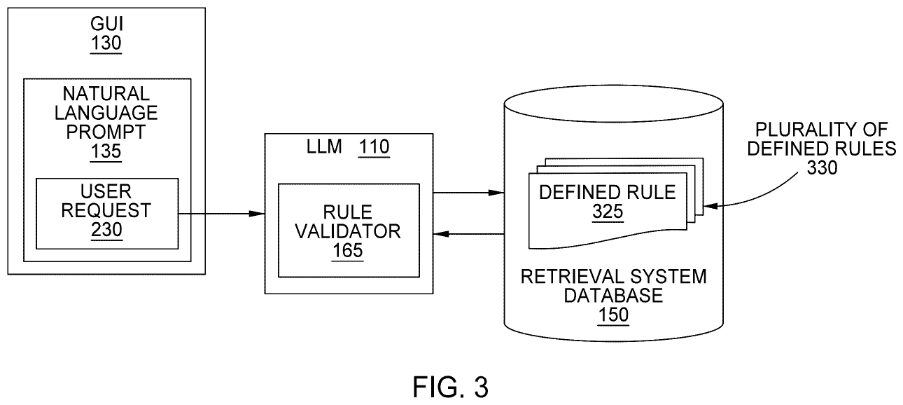

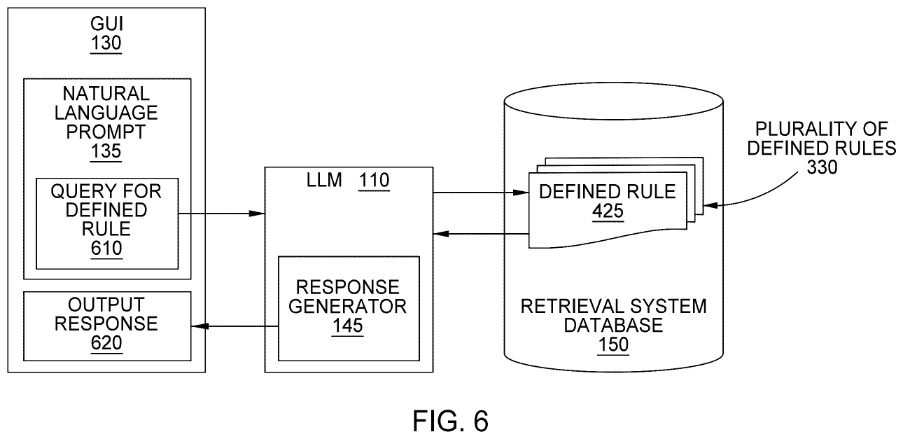

In the sanitization system 100, a LLM 110 receives a plurality of documents 120, and a natural language prompt 135 via a graphical user interface (GUI) 130. The GUI 130 can include a chat feature, enabling the user to easily send and receive prompts. The plurality of documents 120 can be received for sanitization and the natural language prompt 135 can be a user request or instruction, which is discussed in further detail in FIG. 3 and FIG. 6. Sanitization includes removing confidential elements defined by confidentiality rules in the retrieval system database 150 from the plurality of documents 120. Depending on the information contained in the natural language prompt 135, the LLM can communicate with and receive information from the retrieval system database 150, update the retrieval system database 150, or do both, among other things. For example, in some embodiments, the natural language prompt 135 contains a request to define a new confidentiality rule where the rule defines a new element that the sanitization system 100 should redact from the plurality of documents 120. In this embodiment, the LLM 110 both updates the retrieval system database 150 with the new rule (after the request undergoes a rule validation process) and the LLM outputs redacted documents 140 incorporating the update. The rules of the retrieval system database 150 define confidential elements to be redacted from the plurality of documents 120.

Elements of the LLM 110 include but are not limited to a document edit identifier 115, which includes a rule inference generator 125, a rule validator 165, a response generator 145, and a rule applicator 155. Collectively, these components output the redacted documents 140, develop a natural language response for the user which is outputted to the GUI 130, retrieve information from the retrieval system database 150, and update the retrieval system database 150, among other things. These features of the LLM 110 are discussed in more detail in the proceeding figures.

The LLM 110 of the sanitization system 100 may be a public LLM. Public models may be trained on extensive datasets comprising text from diverse sources, enabling the LLM to generate human-like text and perform various natural language processing (NLP) tasks such as translation, summarization, and question answering, among other things.

In embodiments using a public LLM, the LLM 110 can be implemented with the retrieval system database 150. Implementing the LLM 110 with a separate retrieval system database 150 creates a RAGS. RAGS refers to an AI framework involving models that integrate external knowledge retrieved from a database or other sources, enhancing the AI system's response generation capabilities. This approach combines the strengths of retrieval-based models, which fetch information from vast datasets, and generation based models, which create coherent and contextually appropriate responses. By retrieving pertinent data that the general LLM may not already be familiar with, and incorporating that data into the LLM's generation process, RAGS can produce more accurate, informed, and contextually rich responses. This way, the core parameters of the LLM also do not have to change with the introduction of new information, as LLMs in a RAGS can apply their already learned natural language processing capabilities (with their preexisting parameters) to the data retrieved from the external source(s), rather than alter their memorized parameters in accordance with the retrieved data. The sanitization system 100 qualifies as a RAGS as it leverages an LLM 110 that uses external information (information from the retrieval system database 150), to augment its responses. This process allows the LLM 110 to provide more precise and comprehensive answers by combining its inherent language understanding and generation abilities with up-to-date and specific knowledge retrieved from the retrieval system database 150. This RAGS allows the memorized parameters of the LLM 110 to remain unchanged, as new information is provided to the LLM 110 via the retrieval system database 150. This enables the LLM 110 to output robust and up-to-date responses while preventing problems such as overfitting. This integration may be done by downloading the public LLM, such as LLM 110, configuring the LLM 110, and preparing computational resources the LLM 110 will use within the sanitization system 100. This preparation can include fine-tuning the LLM 110 with domain-specific data to tailor its performance to the needs of the sanitization system 100. Fine-tuning can help the model understand the nuances and certain terminology relevant to the retrieval system database 150, improving the LLM's 110 accuracy and relevance.

Furthermore, this integration can involve connecting the LLM 110 to the retrieval system database 150. This connection can be done using APIs or middleware that allow the LLM 110 to send queries to the retrieval system database 150 based on user inputs from the GUI 130, such as the natural language prompt 135. During this process, the LLM 110 can generate queries based on the user inputs, which the retrieval system database 150 can process and use to fetch pertinent data. The retrieved information can be fed back to the LLM 110 to refine and inform the LLM's 110 responses. This bi-directional communication, shown by the arrows between the LLM 110 and the retrieval system database 150, ensures the LLM 110 can access up-to-date and contextually appropriate data from the retrieval system database 150.

Additionally, the interaction between the LLM 110 and the retrieval system database 150 can involve implementing mechanisms for catching frequent queries, optimizing the query generation process, and ensure efficient data transfer between the two subsystems of the sanitization system 100.

In some embodiments, the LLM 110 may output a response to the natural language prompt 135. The LLM 110 generates its response by initially understanding the natural language prompt 135. To achieve this understanding, the LLM 110 can tokenize the input data, breaking the input data down into smaller or individual units such as words or sub-words. The LLM 110 can then use its deep neural network, which is pre-trained on vast amounts of data, to analyze these tokens. The LLM 110 leverages its knowledge of language patterns, context, and semantics to interpret the relationships between the tokens and understand the overall meaning of the prompt. The LLM 110 can also employ attention mechanisms to focus on more relevant aspects of the prompt, ensuring it captures the nuances of key elements. By understanding context, syntax, and the intent behind the prompt, the LLM 110 can generate a meaningful response or take appropriate action.

For example, if the natural language prompt 135 asks “is there a rule for redacting personal identifying information from documents?” the LLM 110 may parse through the prompt to understand the query. The LLM 110 can identify key elements such as “rule,” “redacting,” and “personal identifying information” as key elements. The LLM 110 can then formulate a structured query to search the retrieval system database 150 for rules related to this criteria. The LLM 110 may generate an SQL query such as: ‘SELECT * FROM rules WHERE description LIKE ‘% redact % personal % identification % information’ or a different format interpretable by the retrieval system database 150. The generated query can be sent to the retrieval system database 150, which can search its records and return matching or similar results.

Examples of matching the query to rules in the retrieval system database 150 includes the retrieval system database 150 comparing the words of the query to words in existing rules. Beyond just keyword matching, the LLM 110 can use its understanding of context to ensure the matched rules are relevant. This involves analyzing the surrounding words and the overall sentence structure to confirm the rule pertains to the “redacting personal identification information” in the same context of document sanitization. The LLM 110 can assign a relevance score to the potential word matches queried for based on how well the keywords and context align with the user's query, with higher scores given to rules that are more closely aligned with the intent and specifics of the query. Following this, the LLM 110 can filter out lower scores and validate higher scores to ensure accuracy, and possibly include additional checks to confirm the high scoring information contains the information mentioned in the query.

Based on the LLM's 110 analysis after sending a query to the retrieval system database 150 aiming to extract the relevant information for generating a response to the natural language prompt 135, the LLM 110 can generate its response for the user. The retrieved information is integrated with the LLM's 110 pre-existing knowledge. This integration allow the LLM 110 to generate a response that is accurate and contextually enriched, ensuring the reply is informative and relevant. For example if there are no rule matches, the LLM 110 can inform the user, or in some embodiments, the LLM 110 asks if the user would like to store the rule into the retrieval system database 150. For example, the LLM 110 could output “Yes, there is a rule stating personal identification information must be redacted.'” or “No, there is no rule for that. Would you like to add that rule to the database?”

In some embodiments, the LLM 110 applies rules from the retrieval system database to the plurality of documents 120 using the rule applicator 155. This enables the LLM 110 to output redacted documents 140 based on the rules of the retrieval system database 150. This application from the rule applicator 155 can involve using retrieved rules from the retrieval system database 150 to analyze and process the plurality of documents 120 fed to the LLM 110. The rule applicator 155 can systematically apply each rule to the content of the plurality of documents 120. For example, if a rule indicates that the documents should no longer contain data regarding employees' social security numbers the LLM 110 can check the content of the plurality of documents 120 against the rule criteria, and ensure the conditions are met by removing employees' social security numbers. The LLM 110 uses its natural language understanding capabilities to interpret and enforce rules, modifying the plurality of documents to comply with the rules defined in the retrieval system database.

After applying the rules to the plurality of documents 120, the LLM 110 can review the plurality of documents to ensure the rules have been correctly enforced and the plurality of documents 120 meet the desired standards. Once reviewed, the LLM 110 can output the redacted documents 140 which have been verified to comply with the rules. In some embodiments, the LLM 110 can reword the plurality of documents 120 after applying the rules. The redacted documents 140 can be reworded versions of the originally inputted plurality of documents 120. Redacting and rewording the documents in the outputted redacted documents 140 ensures readability and improves security. Readability of the redacted documents is improved as grammatical integrity can be maintained by rewording documents to ensure there are no gaps or spaces after information has been redacted. Security is improved as documents can be reworded so there are no longer traces of the redacted, sensitive information defined by the rules. For example, if a document is not reworded, the type of information redacted, or even the information itself, can be more easily predicted than in a reworded document that removes context clues that could lead to predicting the redacted data.

The rewording process can involve the LLM 110 analyzing the plurality of documents 120 to grasp their content and context. Analyzing the original components of the plurality of documents can involve the LLM 110 identifying key ideas, themes, and details that should be preserved in the outputted redacted documents 140, while simultaneously eliminating traces of the redacted data, removed as part of the rule application process. The LLM 110 can comprehend the nuances of the documents' 120 language, style, tone, etc. enabling the LLM 110 to generate alternative phrases that maintain the original meaning of the plurality of documents 120, while also understanding the information that should be excluded in the outputted redacted documents 140. The LLM 110 can employ techniques such as synonym replacement, sentence restructuring, and voice changing (i.e. from passive to active) as it sees fit according to the information that should be redacted from the plurality of documents 120 according to the rules of the retrieval system database 150. The LLM 110 can ensure the reworded text (excluding the classified information defined by the rules in the retrieval system database) is readable with proper grammatical structure, is coherent, and retains the relevant portions of the message.

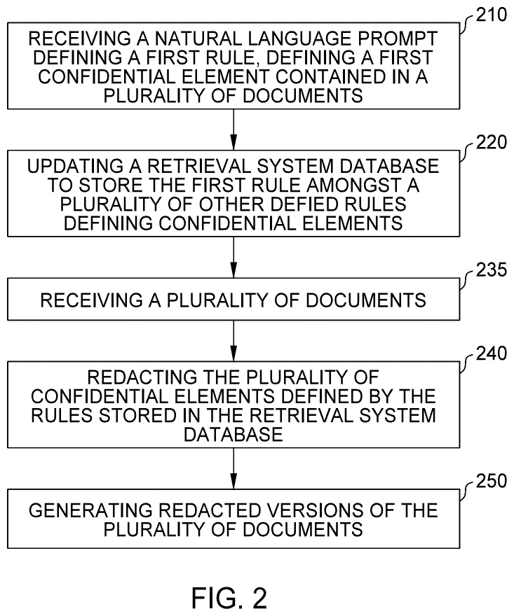

FIG. 2 illustrates a flowchart of generating redacted versions of inputted documents using the sanitization system 100.

At block 210, the LLM receives a natural language prompt defining a rule. In one embodiment, the rule defines a confidential element contained in a plurality of documents.

The LLM can parse and interpret the natural language prompt to understand the certain conditions and criteria constituting the rule. The LLM can use its natural language processing capabilities to extract the key terms, conditions, and logical structures to identify the rule in the natural language prompt provided by the user. This include identifying trigger events, actions to be taken, and any constraints of exceptions, among other things, that may indicate what the rule defines.

Once the LLM interprets what the rule defines, the natural language format can be converted into a structured format suitable for further processing. This can involve transforming the rule into a formalized syntax or schema that aligns with the retrieval system database, among other things.

At block 220, the LLM updates the retrieval system database to store the rule defined in the natural language prompt amongst the plurality of rules of the retrieval system database.

The LLM may ensure the rule is structured. When the structure of the rule is suitable for the retrieval system database, the LLM can interface with the retrieval system database via an API or database management tool, etc. The LLM can generate an appropriate database query or command to insert the new rule into a relevant table or data structure within the database. This process can include ensuring that the rule is indexed and tagged correctly for efficient retrieval and future queries. Automating these steps by the LLM ensures the new rule is stored accurately and is easily accessible for future validation, application, and queries, among other things.

At block 235, the LLM receives a plurality of documents.

The LLM can process the plurality of documents by parsing each document to understand its content and context. The LLM can analyze the text within each document and identify key themes, entities, relationships and relevant details. Using its pre-trained language capabilities, the LLM can extract meaningful insights, summarize content, identify patterns, and compare information across multiple documents of the plurality of documents.

At block 240, the LLM uses the rules defined in the retrieval system database, including the rule that was defined by the natural language prompt, and redacts the elements defined in the rules from the plurality of documents.

When the LLM applies the rules to the plurality of documents, the LLM retrieves the rules from the database. Each of the plurality of documents can be processed individually by the LLM. The LLM can analyze the text of each document to identify areas where the rules are applicable. The LLM can check for certain conditions defined by the rules and apply the corresponding actions dictated by the rules to each document of the plurality of documents. The LLM can ensure each document adheres to the defined standard and guidelines by systematically applying the rules across the plurality of documents. This can involve iterating over the plurality of documents multiple times to ensure the rules are enforced.

At block 250, the LLM generates and outputs redacted versions of the plurality of documents.

Once it is determined that the rules are enforced in the plurality of documents, the LLM may output the redacted versions of the documents where the rules are implemented. The outputted redacted documents may be reworded so that there are no traces of the classified elements defined in the rules that were applied to them. Additionally, they may be reworded by the LLM to maintain a readable and grammatical structure despite having information redacted. This offers improvements to user experience as well as security.

FIG. 3 illustrates the process of storing a new defined rule to the retrieval system database 150 among the plurality of defined rules 330.

Once the LLM 110 detects that the natural language prompt 135 includes a user request 230 to implement a new rule, the LLM 110 can seek to validate the rule embedded in the user request 320 using the rule validator 165. Validating a rule can include determining whether or not the rule already exists, whether or not the rule interferes with an existing rule, and whether or not the rule is feasible for implementation, among other things.

The rule validator 165 can generate a contextually appropriate query based on the rule the LLM 110 identifies in the user request 230. The identification process can include but is not limited to identifying certain keywords, phrases, or criteria relevant to rule structure. Using this information that identifies a rule, the rule validator can generate a query for the rule to be executed in the retrieval system database 150.

The retrieval system database 150 may employ various search algorithms to locate and return documents, records, or data entries that match or align with the query. Techniques such as keyword matching, semantic searching, or natural language processing to ensure the retrieved information is relevant and comprehensive can be utilized.

When the relevant information from the retrieval system database is retrieved, the rule validator 165 may begin to evaluate the validity of the rule defined in the user's natural language prompt 135. The retrieved data can be analyzed by the LLM and compared to the rule defined by the user's natural language prompt 135. This comparison assess the, accuracy, and relevance, among other things that define the validity, of the rule in question. The rule validator 165 can check for consistency, and verify whether or not the conditions to add the rule to the retrieval system database have been met. This may include but is not limited to cross referencing multiple sources, identifying pattern discrepancies, and ensuring the data aligns with the rule's standards.

The rule validator 165 may then perform a rule synthesis where it can consolidate the findings from the data evaluation process into a coherent conclusion regarding the rule's validity. This synthesis can include the LLM 110 generating a response that outlines whether or not the rule is valid, partially valid, or invalid based on evidence from the retrieval system database 150. The LLM 110 can also provide justifications for its conclusion, highlighting pieces of evidence and reasoning used during the validation process.

If the rule embedded in the user request 230 is determined valid, it may be stored in the retrieval system database 150. The LLM 110 may proceed to format the rule so that it can be appropriately stored in the retrieval system database 150. Formatting the rule includes but is not limited to organizing the rule and its associated validation data in a structured manner that aligns with the retrieval system database 150 schema. This structure can include the rule itself, the validation status, relevant metadata (such as the date of validation, the source of the data used for validation, or any related notes or comments, etc.), and links to the plurality of documents 120, among other things.

The LLM 110 may then initiate the valid rule's integration into the retrieval system database 150. This can involve using database management tools or APIs to insert the validated rule into the appropriate tablets or data structures within the retrieval system database 150. For example, if the retrieval system database 150 is a relational database, this might mean inserting a new row into its rules table with columns for each piece of relevant information. If the retrieval system database 150 is a document-oriented database, initiating the valid rule's integration may involve creating a new document entry with fields for the different aspects of the validated rule.

Following integration, an indexing and tagging process may occur ensuring the rule can be efficiently retrieved and used for future queries. Indexing involves creating or updating indexes that allow for fast search and retrieval operations based on the rule's attributes. Tagging can include adding keywords or categories to the rule to facilitate its discovery during searches. Proper indexing and tagging help maintain the performance and usability of the retrieval system, enabling quick and accurate access to the validated rule.

A validation log and audit trail can also be updated, keeping a log of the validation process and any changes made to the retrieval system database 150. This can help maintain transparency in the system. The log may include timestamps, the identity of the user that requested the change or addition of a new rule, etc.

After implementing steps that allow the valid rule to be stored in the retrieval system database, the rule becomes a defined rule 325 among the plurality of defined rules 330 within the retrieval system dataset 150.

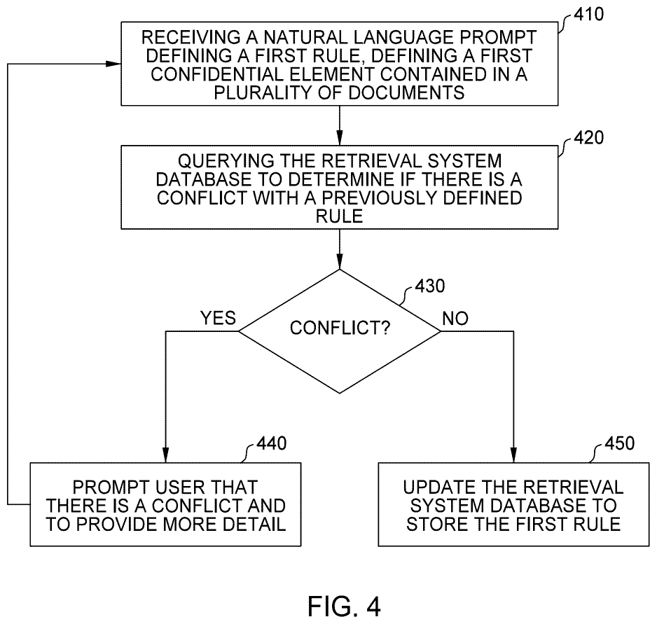

FIG. 4 illustrates a flowchart of validating a new rule and updating the retrieval system database with the new, validated rule.

At block 410 the LLM receives a natural language prompt defining a rule. The rule defines a confidential element that should be removed from the plurality of documents.

The LLM may use its natural language processing capabilities to extract logical structures from the natural language prompt, indicating the rule defined in the natural language prompt. The LLM understands the intent behind the rule and translates the informal description into a formalized representation for further processing during this validation process.

At block 420 the LLM queries the retrieval database system to determine if the confidentiality rule conflicts with a previously defined confidentiality rule stored in the retrieval database system.

Using the formalized representation of the new potential rule, the LLM formulates the query using key elements identified in the potential new rule. The query is used to search retrieval system database for existing rules with overlapping or similar criteria. The query is generated against the stored rules of the retrieval system database to identify potential conflicts. Once the query is executed, the retrieval system database returns existing rules that match the search criteria. The LLM then analyzes these results to check for conflicts, such as contradictory actions for the same condition, or mutually exclusive constraints. By comparing the new rule with the retrieved rules, the LLM can identify and highlight any inconsistencies, or rule conflicts, allowing for further review and resolution before the new rule is finalized and stored in the database. This process ensures the retrieval system database remains coherent and logically consistent.

At block 430 the sanitization system determines whether or not there is a conflict. If there is a conflict, the sanitization system follows the actions set forth in block 440. If there is no conflict, the sanitization system follows the actions set forth in block 450.

In sanitization systems, conflicting rules can involve serval scenarios, often mandating a different procedure than a rule previously defined in the retrieval system database 150. For example, a preexisting rule in the retrieval system database 150 may state that “all personal identifying information must be redacted from documents.” However, the natural language prompt 135 may request a new rule be added to the retrieval system database 150 that states “customer feedback documents must retain original customer information for authenticity verification.” The first example rule focuses on protecting sensitive information, whereas the second example rule emphasizes maintaining data integrity for validation purposes, leading to a direct conflict in how customer information should be handled.

At block 440 the LLM provides a response to the user indicating that there is a conflict. The LLM prompts the user to provide more detail so avert the conflict. For example, using the example rules discussed above, the LLM 110 would have identified a conflict between the rules. With this identification, the LLM 110 can provide a structured response to help resolve or notify the user of the conflict. One example response from the LLM could be “it appears there is a conflict between the existing rule that redacts all personal identifying information from documents, and the new requested rule mandating the retention of original customer information for authenticity verification. There are several options to resolve this. One option includes modifying the first rule. You could modify the first rule to include an exception for customer feedback documents.” The LLM 110 could also provide a prompt of the reworded rule to include this limitation, and confirm whether or not the user would like to proceed with the modification. Another example includes the LLM 110 suggesting adjusting the new potential rule to comply with preexisting guidelines. The LLM 110 can also request additional information from the user. For example, the LLM 110 could provide a response to the user indicating the conflict, but if there are certain circumstances under which both rules can be applied simultaneously, the LLM 110 may ask the user to provide more details enabling the LLM 110 to create a more nuanced rule that satisfies the conflict.

The example responses discussed are non-limiting.

The sanitization system can loop back to block 410 as new rules requests are entered or as the user adjusts the rule.

The LLM can summarize the conflict to the user, specifying which elements of the new rule are in direct contradiction with the existing rules. This can include details such as the conditions, actions, or constraints that overlap or are mutually exclusive.

The prompt is designed to be user friendly, and may provide actionable insights in some embodiments. By offering detailed feedback to the user, the LLM helps the user understand the nature of the conflict, and can guide the user toward resolving the conflict.

By offering options to the user, prompting the user to choose a path that aligns with their operational and compliance desires, the LLM 110 can help resolve any immediate conflicts while also engaging the user in refining the rules to maintain clarity and consistency within the document sanitization process.

At block 450 the LLM updates the retrieval system database to store the rule defined in the natural language prompt.

Once the rule defined in the natural language prompt has been validated, the LLM can store the rule in the retrieval system database. The LLM can extract key elements from the natural language prompt and generate a formal representation of the rule appropriate to store in the retrieval system database.

Once the rule is appropriately structured, the LLM can generate a command to insert the new rule into the relevant table or collection within the retrieval system database. This command can be an insert statement, or a command specific to the database management system in use, among other things. The LLM can execute this command through an API or a direct database connection, ensuring the new rule is accurately stored and indexed for future retrieval and application. This process ensures the rule is systematically integrated into the retrieval system database, making it accessible for automated processing and compliance checking.

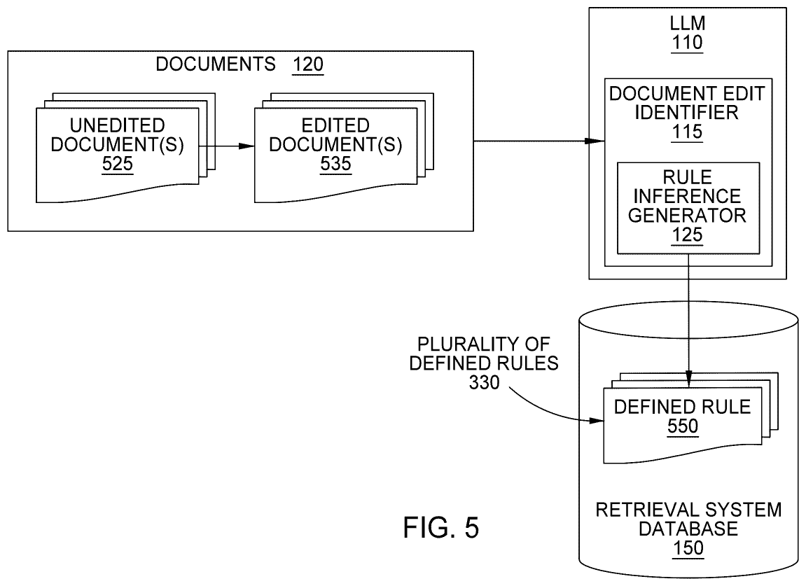

FIG. 5 illustrates the sanitization system 100 using the document edit identifier 115 to generate a new rule. The sanitization system 100 uses the rule inference generator 125 to do so, and stores the new defined rule 550 in the retrieval system database 150.

In some embodiments, a user may manually edit the plurality of documents 120. The document edit identifier 115 of the LLM 110 detects changes from the unedited document(s) 525 to the edited document(s) 535 of the plurality of documents 120. The document edit identifier 115 of the LLM 110 can detect edits or changes made to the plurality of documents 120 by comparing different versions of the same documents to identify alterations (i.e. comparing the unedited document(s) 525 to the edited document(s) 535). The edits may include a user removing elements or adding elements to the plurality of documents 120. The document edit identifier 115 of the LLM 110 can analyze the original, unedited document(s) 525 and the edited document(s) 535 and recognize differences such as word choice, sentence structure, paragraph organization, categorizing the type of information removed or re-included in documents, etc. The document edit identifier 115 can pinpoint certain changes, such as types of additions, deletions, substitutions, and rephrasing incorporated.

Once the edits are identified by the document edit identifier 115, the edits may be categorized based on the type of change, and the context of the edits. For example, the LLM 110 can distinguish between grammatical corrections, stylistic adjustments, and content modifications (such as insertion of deletion of a certain type of information). The LLM 110 can examine the nature of the changes in the edited document(s) 535, allowing the LLM 110 to provide a detailed analysis of the edits, detecting patterns, highlighting significant alterations and their potential impact on the document's overall content.

The rule inference generator 125 can derive rules based on the analysis of the edits identified by the document edit identifier 115. That is, the rule inference generator 125 can infer new rules from the user's actions, without the user having to explicitly provide a new rule to the LLM. Using the identified common pattern or trends in the edits, the rule inference generator 125 can infer general rules or guidelines that govern these changes. For example, if a detected pattern indicates the removal of birthdays from the plurality of documents, the inferred rule from the rule inference generator may be to sanitize documents so that birthdays are redacted.

The inferred rule may be formalized by the LLM 110 to match the format of the plurality of rules 330 stored in the retrieval system database 150.

In some embodiments, derived rule(s) from the rule inference generator may undergo the same validation process discussed in FIG. 3. After undergoing validation, the inferred rule from the rule inference generator 125 may be stored in the retrieval system database 150 as the defined rule 550 of the plurality of defined rules 330.

In some embodiments, the plurality of documents 120 may be automatically re-sanitized by the sanitization system 100 when the system detects an update to the retrieval system database 150. The sanitization system may output the updated redacted documents 140 according to the updated rules of the retrieval system database 150.

Updates to the retrieval system database 150 can also involve removing or cancelling current rules according to rules derived from the rule inference generator 125 or rules derived from a natural language prompt 135.

FIG. 6 illustrates the LLM 110 outputting a response to a user query 610 for a defined rule 425 stored in retrieval system database 150. At the GUI 130, a user may enter a natural language prompt 135 for the LLM 110 to interpret. In some embodiments, the natural language prompt 135 includes a query 610 to determine whether or not a certain rule, such as the rule 425 exists in the retrieval system database 150 among the plurality of defined rules 330.

When a user enters a query 610 into the GUI 130 asking whether a certain rule (such as the defined rule 425) exists, or is currently defied in the retrieval system database 150, the LLM 110 can receive and interpret the user's query 610. The LLM 110 can use its natural language processing capabilities to understand the intent of the query 610, identifying the rule or type of rule (such as the defined rule 425) the user is inquiring about. This may involve parsing the text of the query 610 to extract keywords, phrases, and context that can be used to perform a database search of the retrieval system database 150.

The LLM 110 can use the extracted information to formulate its own search query tailored to the retrieval system database 150. The LLM 110 may convert the user's natural language query 610 into a structured query of a format compatible with the database's search mechanisms. The LLM 110 can take into account the retrieval system database's 150 schema, indexing methods, or attributes of the rules stored in the retrieval system database 150 to create an effective search query. This helps ensure the search of the retrieval system database 150 is both comprehensive and targeted, increasing the likelihood of retrieving relevant results.

Once the search query is prepared, the LLM 110 can execute the query against the retrieval system database 150. The retrieval system database 150 can process the query and search the indexed data (such as the plurality of defined rules 330) for matches. If the rule inquired about in the user query (such as the rule 425) exists in the retrieval system database 150, the system retrieves the relevant records of this, and returns them to the LLM 110. If no matches are found, the retrieval system database 150 indicates the absence of the requested rule. The LLM 110 processes these results at the results generator 145 to generate a meaningful response for the user.

The response generator 145 obtains the search results of the retrieval system database 150 search and analyzes and formats the response. If the rule exists, as the defined rule 425 exists, the response generator 145 of the LLM 110 may generate a response that include details such as the rule's description, creation data, or any associated metadata. If the rule does not exist, the response generated by the response generator 145 may inform the user accordingly, possibly suggesting alternative queries or related rules that might be of interested. The LLM 110 ensures the response is clear, concise, and appropriately addresses the user's query 610.

The response generator 145 takes its generated response and presents it to the GUI 130 as the output response 620. The output response 620 may be presented in a user friendly format, which can include showing a simple confirmation message, providing detailed rule information, or offering additional options for further queries. The LLM 110 ensures the GUI 130 is intuitive and easily understandable, enhancing the user's overall experience. The LLM 110 bridges the gap between the user's natural language query 610 and the plurality of defined rules 330 of the retrieval system database 150.

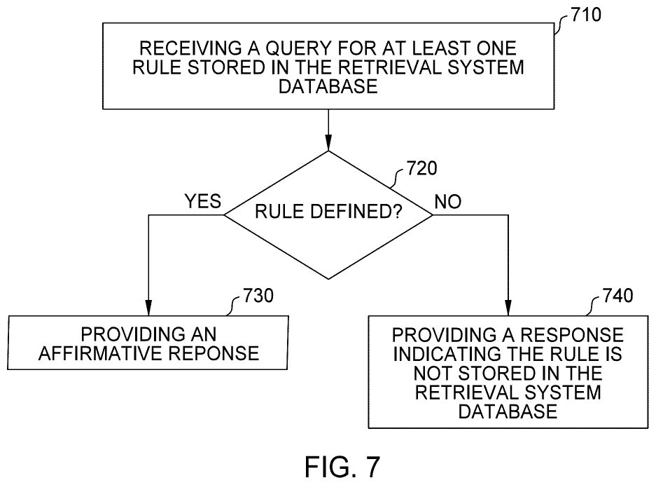

FIG. 7 illustrates a flowchart of querying for a rule in the retrieval system database.

At block 710 the LLM receives a query for at least one rule stored in the retrieval system database. This process is discussed in detail in FIG. 6.

At block 720 the LLM determines whether or not the rule being queried for is defined in the retrieval system database. If the LLM determines that the rule is defined, the sanitization system executes block 730. If the LLM determines that the rule is not defined, the sanitization system executes block 740.

At block 730 the LLM provides an affirmative response to the user at the GUI, informing them that the rule queried for is defined in the retrieval system database.

The LLM's response is formulated to clearly state that the rule is present. The response may include additional information, such as the rule's description, metadata or any other details that validate its existence in the retrieval system database.

At block 740 the LLM provides a response to the user at the GUI informing them that the rule queried for is not defied in the retrieval system database.

The LLM's response may indicate that the search query returned no matching records. The LLM verifies the absence of the rule by cross-referencing search results with the criteria specified in the query. The response from the LLM is clearly phrased to inform the user that the rule was not found.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A method comprising:
receiving a first confidentiality rule defining a first confidential element contained in a plurality of documents;
updating a retrieval system database to store the first rule, wherein the retrieval system database stores a plurality of defined rules that define a plurality of confidential elements;
receiving the plurality of documents, at a large language model (LLM);
redacting, using the LLM, the plurality of confidential elements defined by the rules stored in the retrieval system database from the plurality of documents, including the first confidential element defined by the first rule; and
generating, using the LLM, redacted versions of the plurality of documents.

2. The method of claim 1, wherein the LLM utilizes a retrieval augmented generation system (RAGS), wherein updates to the retrieval system database enable the LLM to generate up-to-date responses while memorized parameters of the LLM remain unchanged.

3. The method of claim 1, further comprising:
receiving a natural language prompt to remove the first rule from the retrieval system database;
updating the retrieval system database to remove the first rule from the plurality of defined rules it stores;
receiving the plurality of documents;
redacting the plurality of confidential elements defined by the rules stored in the retrieval system database from the plurality of documents, wherein elements defined by the first rule are not redacted; and
generating redacted versions of the plurality of documents.

4. The method of claim 1, further comprising:
detecting a user removing elements from at least one of the plurality of redacted documents;
inferring, by the LLM, a second rule, wherein the second rule defines a confidential element contained in the plurality of documents based on the elements removed by the user; and
updating the retrieval system database to store the second rule.

5. The method of claim 1 further comprising:
receiving a natural language query for at least one rule stored in the retrieval system database; and
providing a natural language response to a graphical user interface (GUI), wherein the response comprises at least one of:
a list of the rules stored in the retrieval system database;
an indication that the rule is defined and stored in the retrieval system database; or
an indication that the rule is not defined nor stored in the retrieval system database.

6. The method of claim 1, further comprising:
detecting, at the LLM, that the first confidentiality rule conflicts with at least one of the plurality of defined rules stored in the retrieval system database; and
providing a prompt to a GUI requesting to receive more detail to define the first rule in the retrieval system database.

7. The method of claim 6, wherein a rule conflict comprises the first confidentiality rule mandating a different procedure than at least one of the plurality of defined rules stored in the retrieval system database.

8. The method of claim 1, further comprising:
rephrasing, using the LLM, a sentence containing redacted data to maintain user readability and grammatical structure so that first confidential element is removed but the redacted versions of the documents remain user readable with proper grammatical structure.

9. The method of claim 8, wherein rephrasing a sentence containing redacted data improves document security by eliminating more traces of the confidential elements.

10. The method of claim 3, wherein the natural language prompt is received through a GUI, wherein the GUI includes a chat feature.

11. The method of claim 3, wherein the natural language prompt is derived, by the LLM, into a third rule stored in the retrieval system database.

12. A system comprising:
one or more processors; and
one or more memories configured to store an application, which, when executed by a combination of the one or more processors, causes the combination of the one or more processors to perform an operation, the operation comprising:
receiving a first confidentiality rule defining a first confidential element contained in a plurality of documents;
updating a retrieval system database to store the first rule, wherein the retrieval system database stores a plurality of defined rules that define a plurality of confidential elements;
receiving the plurality of documents, at an LLM;
redacting the plurality of confidential elements defined by the rules stored in the retrieval system database from the plurality of documents, including the first confidential element defined by the first rule; and
generating redacted versions of the plurality of documents.

13. The system of claim 12, wherein the LLM utilizes a retrieval augmented generation system, wherein updates to the retrieval system database enable the LLM to generate up-to-date responses while memorized parameters of the LLM remain unchanged.

14. The system of claim 12, further comprising:
receiving a natural language prompt to remove the first rule from the retrieval system database;
updating the retrieval system database to remove the first rule from the plurality of defined rules it stores;
receiving the plurality of documents;
redacting the plurality of confidential elements defined by the rules stored in the retrieval system database from the plurality of documents, wherein elements defined by the first rule are not redacted; and
generating redacted versions of the plurality of documents.

15. The system of claim 12, further comprising:
detecting a user removing elements from at least one of the plurality of redacted documents;
deriving, by the LLM, a second rule, wherein the second rule defines a confidential element contained in the plurality of documents based on the confidential elements removed by the user; and
updating the retrieval system database to store the second rule.

16. The system of claim 12 further comprising:
receiving a natural language query for at least one rule stored in the retrieval system database; and
providing a natural language response to a graphical user interface (GUI), wherein the response comprises at least one of:
a list of the rules stored in the retrieval system database;
an indication that the rule is defined and stored in the retrieval system database; and
an indication that the rule is not defined nor stored in the retrieval system database.

17. The system of claim 12, further comprising:
detecting, at the LLM, that the first confidentiality rule conflicts with at least one of the plurality of defined rules stored in the retrieval system database; and
providing a prompt to a GUI requesting to receive more detail to define the first rule in the retrieval system database.

18. The system of claim 12, wherein in the redacted versions of the documents, the LLM rephrases a sentence containing redacted data to maintain user readability and grammatical structure so that first confidential element is removed but the redacted versions of the documents remain user readable with proper grammatical structure.

19. The system of claim 18, wherein rephrasing a sentence containing redacted data improves document security by eliminating more traces of the confidential element.

20. The system of claim 14, wherein the natural language prompt is derived into a third rule stored in the retrieval system database.
